(19) United States
(12) Patent Application Publication
(10) Pub. No.: US 2026/0004976 A1
(43) Pub. Date: Jan. 1, 2026

(54) Electrolyte, Capacitor And Method Of Measuring Oxide Creation Capability

(71) Applicant: TDK Electronics AG, München (DE)

(72) Inventors: László Dobai, Szeleste (HU); Zita Dominkovics, Sarvar (HU)

(21) Appl. No.: 18/782,402

(22) Filed: Jul. 24, 2024

(30) Foreign Application Priority Data
Jun. 28, 2024 (DE) 102024118375.6

(51) Int. Cl. H01G 9/035; G01N 27/416; H01G 9/045; H01G 9/052

(52) U.S. Cl. CPC H01G 9/035; G01N 27/4166; H01G 9/045; H01G 9/052

(57) ABSTRACT

An electrolyte for an electrolytic capacitor and a capacitor having said electrolyte are provided. The electrolyte has an oxide creation capability (OCC) value of at least 1.3 V/s or a refractive index of at least 1.42 at 20° C.

### FIELD OF THE INVENTION

There is a high demand for the provision of volume-efficient capacitors. This means that there is a high demand for the capacitance of a capacitor to be increased while maintaining its size or for miniaturizing a capacitor while maintaining its capacitance.

### BACKGROUND OF THE INVENTION

In this context, the inventors of the present invention found that at least some capacitors with high volume efficiency tend to have a reduced lifetime under the same operation conditions as less volume-efficient capacitors.

Accordingly, it is an aim of the present application to provide a capacitor which can have an improved lifetime. According to another aim a capacitor may be provided that can have improved volume efficiency.

The electrolytes of claims 1 and 5 and the capacitor of claim 11 help to at least partially overcome some of the above-stated problems or at least partially help to fulfil at least one of the above-stated aims. Advantageous embodiments are provided in the dependent claims.

### SUMMARY OF THE INVENTION

The inventors of the present invention have found that sintered anodes may help to increase the volume efficiency of a capacitor. A so-called sintered anode has a sintered portion. Said sintered portion comprises merged metallic particles which can, for example, be formed by sintering from a powder or a powder slurry. Any anode having a sintered portion can be addressed as a sintered anode.

According to an embodiment, a sintered anode can comprise one or more valve metals. Preferably, a sintered portion comprises said one or more valve metals. “Valve metals” can be understood in the general technical sense and are not limited. For example, valve metals at least include aluminum, titanium, tantalum, niobium, tungsten, chromium, zirconium, hafnium, zinc, vanadium, bismuth and antimony. Of these in particular aluminum, tantalum and vanadium are preferred. Most preferred is aluminum.

According to an embodiment the sintered anode can be a so-called bulk anode which has a sintered portion as a main body. For example, a lead tab can be used to contact said sintered anode.

According to an embodiment that can be preferably used for a capacitor having a winding element, the sintered anode has a substrate which comprises a first valve metal and a sintered portion on at least one main surface of the substrate. The valve metal in the substrate and the valve metal in the sintered portion may be the same or different. Preferably both the substrate and the sintered portion comprise aluminum or have aluminum as a main component.

High surface area anodes in general, which includes some etched anodes and in particular sintered anodes, can lead to increased gas formation and increased leakage currents. In the case of the sintered anodes this can occur during processing, for example due to slitting, winding or cold-welding delamination or cracking of the sintered portion. The chemical reactions at these bare metal sides can create gases. Due to the mechanical properties of sintered anodes, usually mild forming parameters applied, like low temperature heat treatment or low concentration and low temperature during chemical depolarization treatments. Thus, the number of defects in the oxide layer is not sufficiently reduced, and insufficient rehealing of the oxide can be achieved by this. This can cause high leakage currents during storage and high operational leakage currents in the capacitor. In addition, there is the issue of hydration when using multi-polarization, against which the oxide layer may also not be stable.

The inventors found that it is advantageous if the electrolyte is capable of oxidizing said portions. In particular, the inventors found that an electrolyte with good oxide creation capability (OCC) is advantageous and can help to increase the lifetime of a capacitor.

According to an embodiment, an electrolyte is provided that has an oxide creation capability value of at least 1.3 V/s. This value allows for quick formation of oxides for bare metal portions, such as crack sites or delamination sites, in the working electrolyte of the capacitor. When having an OCC of 1.3 V/s or above, the electrolyte can advantageously be used for a sintered anode in a capacitor.

Furthermore, according to an embodiment, the inventors of the present invention have found that a maximum voltage according to an embodiment can be 400 V or above.

Measuring the OCC is generally not limited. In particular it can be recorded by any means of plotting the development of the oxidation voltage as a function of time applied to a standardized aluminum anode having defect sites.

In particular and most preferably, the OCC is measured by the following process. First two mainly identical aluminum foils are provided. These aluminum foils have an aluminum purity of at least 99.96 wt % in their metal portion. These aluminum foils each have two main surfaces which have an oxide of at least 620 nm thickness which insulates said surfaces. This oxide preferably is a gamma aluminum oxide. However, the edges of the foils are only covered by a thin natural oxide that forms on aluminum exposure to air. Such an oxide may be a few nanometers thick, such as 2 to 3 nm. The thickness of the aluminum foils before forming the 620 nm thick oxide is 150 μm. The width of both foils is 5 mm and the height of each foil is 70 mm. One of the foils is used as an anode, the other as a cathode. Therefore, the foils are immersed 20 mm deep into the electrolyte of which the oxide creation capability is to be measured. The measurement is carried out at a temperature of 85±1° C. of the electrolyte. For example, the measurement can be carried out in a double-walled glass beaker. The electrolyte temperature can be controlled, for example, by a thermostat having a circulated water bath. The anode and the cathode are then connected to a power supply. This power supply has to be capable of being set to technically infinite voltage. An upper voltage limit for the power supply of 700 V should suffice for the experiments. The power supply, for example, can be a LTRONIX B606DPM-L 700 V. The current is set to 1 mA. Accordingly the power supply forces a constant 1 mA current to be flowing between anode and cathode. At the moment the power is applied and the current starts to flow, the voltage applied by the power supply is recorded in dependence on time. As the oxide grows due to oxidation of the anode, the voltage that is applied by the power supply to maintain the 1 mA continuously increases. In a so-called linear range, which is between 300 and 400 V, the slope of the curve is measured for example by applying a linear fit. This slope is the OCC value.

At a voltage of above 400 and more preferably above 450 or even more preferably above 475 V, an inflection point can be reached in which the charge transport mechanism changes and sparking appears. From this on there is no further oxide growth. As described above, it is preferred that this maximum voltage is not too low (preferably above 400 V) so that the electrolyte is capable of growing a sufficiently thick oxide.

The inventors have found that electrolytes fulfilling the above defined OCC are advantageous for the reasons explained. By defining the OCC the inventors found a value that, independent of the specific composition of the electrolyte, can define the properties of an electrolyte that is particularly well-suited for sintered foils.

According to another embodiment, which can be but is not necessarily combined with the previous embodiments, the inventors found that advantageous electrolytes for use in a capacitor, and in particular for use in a capacitor having a sintered anode, have a refractive index of 1.42 measured at a temperature of 20° C.

In particular, the inventors have found that electrolytes having a refractive index of 1.42 at 20° C. or above have an overall advantageous composition to reduce gas generation. In particular, electrolytes having said refractive index of at least 1.42 at 20° C. often have reduced water content, which helps to reduce gas generation.

According to an embodiment, the electrolyte comprises a boron compound. In particular and most preferably, the electrolyte comprises a boron oxide compound. An alternative boron compound can be boric acid. Boron compounds in general and boron oxide and boric acid, together with other constituents of the electrolyte, are capable of being a water source that is not present as free water. The inventors have found that using boron oxide or boric acid allows for provision of the oxidizing capabilities of water to an electrolyte without drawbacks such as hydration of oxide.

According to an embodiment, the content of the boron compounds such as boron oxide or boric acid, can be 2 to 4 wt %. Preferably, it can be 2.75 to 3.25 wt %, such as 3±0.1 wt %.

According to another embodiment, the electrolyte can comprise polyethylene glycol or derivatives of polyethylene glycol. The content of polyethylene glycol or polyethylene glycol derivatives can be between 4 to 7 wt %.

Furthermore, according to another embodiment the pH of the electrolyte can be between 4.7 to 6.6. Preferably the pH is in the range of 4.9 to 6.4. The inventors have found that in this pH range, several examples that fulfill the above OCCs can be found.

According to a further embodiment, the conductivity of the electrolyte is 3000 μS/cm or below at a temperature of 30° C. Even more preferably, the conductivity is 2700 μS/cm or below at 30° C. Having this low conductivity helps leakage currents to be reduced.

Furthermore, the inventors found that water can be disadvantageous in electrolytes for the above-named reasons. According to an embodiment, from the constituents added for forming the electrolyte, a water content is preferably below 1%. Even more preferably it is below 0.5 wt % and even more preferably no water is added at all. Please note that the other constituents of the electrolyte may produce small quantities of water upon mixing.

According to a further embodiment, an electrolyte has the following constituents: The amount of ethylene glycol in an electrolyte can be between 74 wt % and 86 wt %. The amount of polypropylene can be between 0 wt % and 10 wt %. The amount of diethylene glycol can be between 0 wt % and 10 wt %. The amount of a dicarboxylic acid such as for example sebacic acid or azelaic acid can be between 3 wt % and 6 wt %, such as between 4 and 5 wt %. The amount of ammonia can be between 0.7 wt % and 0.9 wt %, such as between 0.75 wt % and 0.8 wt %. The amount of polyvinyl alcohol can be between 0 wt % and 1 wt %. For example, it can be 0.75 or 1 wt %. The polyethylene glycol content can be between 4 wt % and 7 wt %. For example, the amount of shorter polyethylene glycol with 300 to 500 repeating units on average can be present in an amount between 0 and 5% and a polyethylene glycol with an amount of 1500 to 2500 repeating units can be present between 0 and 4 wt %. An amount of p-nitroacetophenone can be present in an amount of 0.5±0.2 wt % or more preferably of 0.5±0.1 wt %. The amount of boron oxide or boric acid can be the amount defined above.

The inventors have found that these compositions help to reduce gas generation or achieve the above OCC value or the above-defined refractive index. The content values provided here individually help to achieve this.

According to a further embodiment, a capacitor is described. The capacitor has an anode and a cathode. The anode and the cathode can be arranged as part of a capacitive element. The capacitive element can be configured to be charged and discharged during operation of the capacitor. The capacitive element, or the cathodes and anodes therein, can be contacted by electrically conductive elements such as wires, leads or lead tabs. Preferably, the capacitive element can be a winding element in which the anode and the cathode are wound. Furthermore, it is preferred that the capacitor is an electrolytic capacitor in which a separator is arranged between anode and cathode. The separator can be drenched or soaked with the electrolyte. Preferably, the electrolyte is the above-defined electrolyte. Furthermore, as described above, the anode can be a sintered anode, as described above.

Further advantageous embodiments and further embodiments of the electrolyte or the capacitor may become apparent from the following exemplary embodiments described in connection with the figures. Please note that the invention is not limited to said exemplary embodiments shown in the figures and explained in their context. Further, please note that said exemplary embodiments at least partially depict figures showing schematic drawings. These schematic drawings are not true to scale and absolute and relative dimensions can be depicted in a distorted manner. Individual elements may be shown exaggeratedly large for better representability or better understanding. Accordingly, no absolute or relative dimensions can be taken from the schematic depictions unless otherwise indicated.

### BRIEF DESCRIPTION OF THE DRAWINGS

FIG. 1 shows an embodiment of a capacitor.

FIG. 2 shows the OCC curves for exemplary embodiments of electrolytes.

FIG. 3 shows the results of a storage test comparison between a comparative electrolyte and an exemplary embodiment of an electrolyte according to the invention.

### DETAILED DESCRIPTION OF THE DRAWINGS

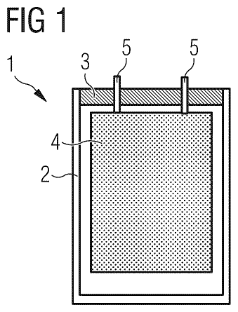

In FIG. 1 a capacitor 1 is shown in schematic cross-section. The capacitor 1 has a case 2 that is closed by a cover 3. Together, cover and case make up a housing. Generally, any other housing can be used for the capacitor as well. A winding element 4, which is an example of a capacitive element, is arranged inside this housing. Though not explicitly depicted, the winding element comprises a cathode which can be any suitable cathode. In addition, it comprises an anode which can be a sintered anode having a substrate of aluminum and an aluminum particle-based sintered portion arranged on each main surface of the substrate. Furthermore, anode and cathode are separated by a separator paper in the winding element. The separator paper is soaked with an electrolyte. The electrolyte has an OCC value of 1.3 V/s or higher and a refractive index of at least 1.42 at 20° C. The anode and the cathode are contacted by lead tabs 5.

For example, the following electrolyte compositions can be used, as shown in Table 1.

TABLE 1

Compositions

| Components | E600 | E601 | E602 | E603 |
|---|---|---|---|---|
| Ethylene-glycol (in wt %) | 85.7 | 74.7 | 75.7 | 74 |
| Propylene-glycol (in wt %) | | | 10 | |
| Diethylene- glycol (in wt %) | | 10 | | 10 |
| Sebacic acid (in wt %) | 5 | 5 | 5 | |
| Azelaic acid (in wt %) | | | | 4 |
| Ammonia (in wt %) | 0.8 | 0.8 | 0.8 | 0.75 |
| Polyvinil alcohol (in wt %) | 1 | | | 0.75 |
| PEG 400 (in wt %) | | 4 | 5 | 5 |
| PEG 2000 (in wt %) | 4 | 2 | | 2 |
| p-nitroacetophenone (in wt %) | 0.5 | 0.5 | 0.5 | 0.5 |
| Boron oxide (in wt %) | 3 | 3 | 3 | |
| Boric acid (in wt %) | | | | 3 |

The inventors have found that the compositions of electrolytes shown in Table 1 or variations as explained in the introduction are advantageous for use in the capacitor shown in FIG. 1.

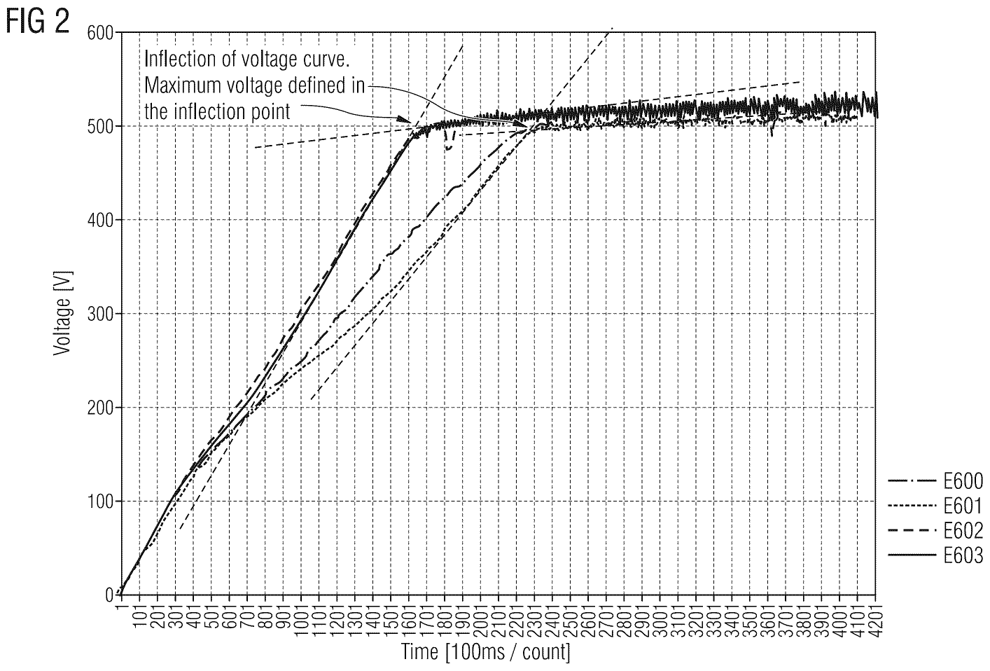

The analysis of these electrolytes is depicted in FIG. 2. The blue graph is associated with electrolyte E600. The orange graph is associated with electrolyte E601. The grey graph is associated with electrolyte E602. The yellow graph is associated with electrolyte E603. The electrolytes shown in Table 1 were each provided in a double-walled glass beaker that is held at a temperature of 85±1° C. by a thermostat. The thermostat uses a circulated water bath. An anode and a cathode are provided, which are constructed in the same manner. Both have a thickness of 150 μm before formation of an oxide. The width of the foil is 5 mm. The height of the foil is 70 mm. The main flat surfaces of the anode foil and the cathode foil are oxidized and have a gamma alumina oxide of at least 620 nm. However, the edges of the foils are not coated by a thick oxide and only have a natural oxide which, for example, has a thickness in the range of 2 to 3 nm. The purity of the foil as provided before oxidization is 99.95 wt % or higher. Both anode and cathode are immersed in the working electrolyte, which is kept at a temperature of 85±1° C. The immersion depth is 20 mm. Both anode and cathode are contacted by a power supply LTRONIX B606DPM-L 700V. The power supply is set to the maximum voltage of 700 V and a fixed current is set to 1 mA. As is shown in FIG. 2, the voltage that is applied by the power supply in order to maintain the current of 1 mA is recorded as a function of time. The relevant value obtained from the plots here, is the average slope between 300 V and 400 V. This value can be read out by any means. For example, a fit curve could be applied to this region. All of the electrolytes have been shown to have an average slope of above 1.3 V/s. Accordingly, they have advantageous properties. As can be seen from the curves, the electrolytes E602 and E603 have even better OCC and are more advantageous. Please note that an inflection point of the voltage curve can be observed for each curve. Above the inflection point sparking can take place through the oxide and no further oxide growth takes place. This is the maximum voltage that can be applied to the electrolyte. Said maximum voltage for all of the electrolytes is clearly above 400 V. Please note that the straight lines drawn into the graphs are not fit-functions but merely highlight the formation of an inflection point and the two different regimes of charge transport.

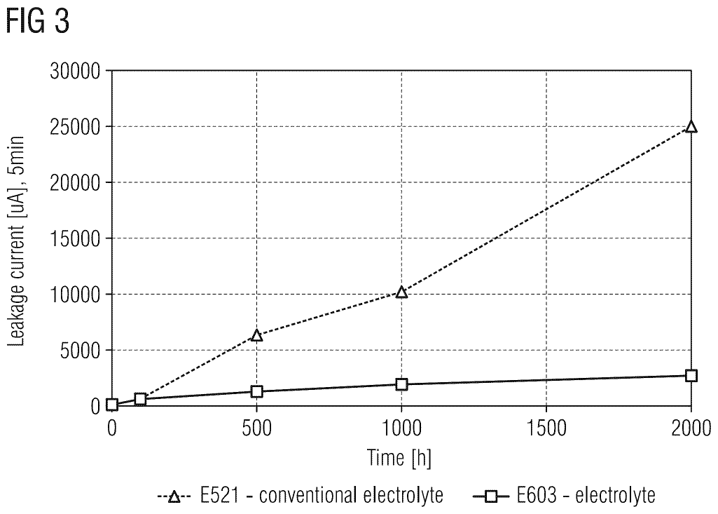

In FIG. 3 and in Table 2, a comparative electrolyte named “E521—conventional electrolyte” (steeper curve; grey color), which does not have an OCC of 1.3 V/s or above or a refractive index of at least 1.42 at 20° C., is compared to the electrolyte E603 (less steep curve; blue color) in a storage test. The values measured for this test are summarized in Table 2. This test is carried out as follows. The capacitor having the electrolyte E603 is stored for the time depicted. The leakage current is always measured five minutes after applying the working voltage to the capacitor. As can be seen from FIG. 3 as well as from Table 2 below, for storage times of 500 hours and above, the capacitor having the inventive electrolyte considerably outperforms the conventional electrolyte. The inventors attribute this to the oxide creation capability.

| | LC (μA), 5 min - | | LC (μA), 5 min - | | LC (μA), 5 min - | |
|---|---|---|---|---|---|---|
| Time | average | | minimum | | maximum | |
| [h] | E521 | E603 | E521 | E603 | E521 | E603 |
| 0 | 142 | 165 | 124 | 161 | 156 | 173 |
| 96 | 633 | 648 | 529 | 614 | 724 | 677 |
| 500 | 6353 | 1325 | 1559 | 1275 | 14743 | 1393 |
| 1000 | 10155 | 1939 | 2097 | 1895 | 39661 | 2014 |
| 2000 | 24984 | 2717 | 5996 | 2609 | 98622 | 2822 |

### REFERENCE SIGNS

1 capacitor
2 casing
3 cover
4 winding element
5 lead tab

1-14. (canceled)

15. An electrolyte for an electrolytic capacitor having an oxide creation capability (OCC) value of at least 1.3 V/s.

16. The electrolyte according to claim 15, wherein the electrolyte has a maximum voltage of at least 400 V.

17. The electrolyte according to claim 15, wherein the oxide creation capability (OCC) value is measured by
providing two aluminum foils having a purity of 99.96 wt % or higher, wherein the main surfaces of the aluminum foils have a grown oxide of at least 620 nm thickness and the edges are covered by natural oxide only, and wherein the thickness of the plain aluminum foils before applying the grown oxide is 150 μm, and wherein the width of each aluminum foil is 5 mm,
immersing both foils as anode and cathode 20 mm deep in the electrolyte at a temperature of 85±1° C.,
connecting anode and cathode to a power supply set to technically infinite voltage and limiting the current to 1 mA,
recording the voltage as a function of time, and
calculating the average slope of the curve between 300 and 400 V.

18. The electrolyte according to claim 15, wherein the electrolyte has a refractive index of at least 1.42 at 20° C.

19. The electrolyte according to claim 15, comprising boron and/or boron oxide.

20. The electrolyte according to claim 15, comprising polyethylene glycol or derivatives of polyethylene glycol.

21. The electrolyte according to claim 15, wherein the electrolyte has a pH of 4.7 to 6.6.

22. The electrolyte according to claim 15, wherein the electrolyte has a conductivity of 3000 μS/cm or below at a temperature of 30° C.

23. The electrolyte according to claim 15, wherein a native water content of the electrolyte before mixing all components of the electrolyte is below 1 wt %.

24. The electrolyte according to claim 15, further in combination with an anode and a cathode to form an electrolytic capacitor.

25. The combination according to claim 24, wherein the anode of the capacitor has a sintered portion.

26. The combination according to claim 24, wherein the anode of the capacitor comprises aluminum.

27. An electrolyte for an electrolytic capacitor having a refractive index of at least 1.42 at 20° C.

28. The electrolyte according to claim 27, comprising boron and/or boron oxide.

29. The electrolyte according to claim 27, comprising polyethylene glycol or derivatives of polyethylene glycol.

30. The electrolyte according to claim 27, wherein the electrolyte has a pH of 4.7 to 6.6.

31. The electrolyte according to claim 27, wherein the electrolyte has a conductivity of 3000 μS/cm or below at a temperature of 30° C.

32. The electrolyte according to claim 27, wherein a native water content of the electrolyte before mixing all components of the electrolyte is below 1 wt %.

33. The electrolyte according to claim 27, further in combination with an anode and a cathode to form an electrolytic capacitor.

34. The combination according to claim 33, wherein the anode of the capacitor has a sintered portion.

35. The combination according to claim 33, wherein the anode of the capacitor comprises aluminum.

36. A method of determining the oxide creation capability of an electrolyte, comprising:
providing two aluminum foils having a purity of 99.96 wt % or higher, wherein the main surfaces of the aluminum foils have a grown oxide of at least 620 nm thickness and the edges are covered by natural oxide only, and wherein the thickness of the plain aluminum foils before applying the grown oxide is 150 μm, and wherein the width of each aluminum foil is 5 mm;
immersing both foils as anode and cathode 20 mm deep in the electrolyte;
connecting the anode and the cathode to a power supply set to technically infinite voltage and limiting the current to 1 mA;
recording the voltage as a function of time; and
calculating the average slope of the curve between 300 and 400 V.
